(19) United States
(12) Patent Application Publication
(10) Pub. No.: US 2006/0133089 A1
(43) Pub. Date: Jun. 22, 2006

(54) Inspection light assembly

(75) Inventors: Thomas J. Reid, White Bear Lake, MN (US); Virgil L. Peterson, Coon Rapids, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/013,633

(22) Filed: Dec. 16, 2004

(51) Int. Cl. F21V 29/00

(52) U.S. Cl. 362/294; 362/373; 362/1; 362/109; 362/399

(57) ABSTRACT

A portable cordless inspection light assembly including a lamp capable of producing a spectral distribution, which is substantially identical to daylight, color temperature. The lamp has a reflector portion around its bulb and a light outlet lens across its large end. The light includes a housing having a generally tubular housing portion. The lamp is mounted within an opening in that housing portion adjacent one end with its large end across the opening and its reflector portion extending along the opening toward the opposite end of the housing portion. Passageway portions of the through opening are provided around the large end of the lamp, and a fan assembly within the opening can propel air through the opening over the outer surface of the lamp and through those passageway portions to cool the lamp. The housing includes a manually engageable handle portion, and supports a rechargeable battery by which the bulb and fan assembly can be activated.

### FIELD OF THE INVENTION

The present invention relates to light source assemblies that produce light generally equivalent to sunlight that can be used to inspect surfaces such as newly painted surfaces.

### BACKGROUND OF THE INVENTION

There are many situations in which it is desirable to inspect a surface with a light generally equivalent to sunlight, for example, to determine the color of that surface under such light or to better see defects or irregularities in that surface. One such situation is when surfaces (e.g., surfaces of an automobile body) are being painted indoors, and it is impractical or impossible to move that surface outdoors into the sunlight.

Lamps have been developed that are capable of producing a light that is substantially identical to daylight color temperature (e.g., the lamp described in U.S. Pat. No. 5,418,419 (McGuire) and commercially available under the trade designation “SoLux” from Tailored Lighting Inc, Pittsford, N.Y.).

Tests we preformed have indicated that a lamp of the type described in U.S. Pat. No. 5,418,419, (i.e., the lamp commercially available under the trade designation “SoLux” 4700K lamp from Tailored Lighting Inc, Pittsford, N.Y.) when activated by a 12 volt D.C. power supply will reach outer surface temperatures of over 370° F. and as high as 490° F. that are sufficient to soften, deform, or melt thermoplastic materials such as polyethylene, polypropylene, ABS, or polycarbonate from which the housings of many light assemblies are made.

Inspection light assemblies that can be used for inspecting paint with light similar to daylight are commercially available from Tailored Lighting Inc., Rochester, N.Y., including the inspection light assembly commercially designated the “Solar Simulator 38”. Those inspection light assemblies, however, are supported on the ground or a fixed structure, and are powered through a transformer and rectifier by alternating current power so that they must be connected to a source of such power through a cord. Thus, the light source can not easily be moved over a surface, and before the light source assembly can be used a power outlet must be present, and the cord, which limits the distance the light source can be used from an electrical outlet, must be connected to the outlet.

U.S. Pat. No. 6,633,110 (McGuire et al) describes a lamp assembly including a lamp of the type described in U.S. Pat. No. 5,418,419, which lamp assembly includes a D.C. power supply so that it is portable, and is waterproof and intended for use under water. Activation of the lamp in that lamp assembly causes sufficient heat that the housing includes internal heat shields, and the lamp assembly includes a housing that is apparently made of materials (e.g., aluminum) with high thermal conductivities. U.S. Pat. No. 6,633,110 indicates that the lamp assembly described can be used outside of water if heat dissipating fins are disposed on the outside surface of the housing.

### SUMMARY OF THE INVENTION

The present invention can provide a completely portable cordless inspection light assembly that can be used to inspect a surface with a light generally equivalent to sunlight, (e.g., to determine the color of that surface under such light or to better see defects or irregularities in that surface), which light assembly includes a sufficiently efficient lamp cooling system that a housing for the light assembly can be made of the relatively inexpensive polymeric materials that are commonly used for the housings conventional light assemblies.

The portable cordless inspection light assembly according to the present invention generally comprises (1) a lamp (e.g., a lamp capable of producing a spectral distribution which is substantially identical to daylight color temperature such as the lamp described in U.S. Pat. No. 5,418,419), which lamp has a larger cross sectional area at a second end than at a first end, has a reflector portion adjacent and a light outlet lens across its second end, and has an electrically operable bulb partially within the reflector portion with electrical contacts for the bulb at its first end; (2) a housing comprising a generally tubular housing portion having an axis, and a through axially extending opening between a first end and a second end of the housing portion; (3) means for mounting the lamp within the opening with the second end of the lamp transverse of the opening adjacent the second end of the housing portion and with the lamp between its first and second ends extending along the through opening toward the first end of the housing portion; (4) means for providing air passageways communicating externally of the housing portion from the through opening around the outer surface of the lamp and adjacent the second end of the lamp; (5) a fan assembly within the opening through the housing portion, the fan assembly being electrically operable to propel air through the opening over an outer surface of the lamp and through the air passageways around the second end of the lamp; (6) the housing further comprising a handle portion adapted for manual engagement; and (7) the inspection light including means for connecting a source of electrical power to the bulb and fan assembly.

The inspection light assembly can include a receptacle engaged with the electrical contact contacts at the first end of the lamp, means for supporting the receptacle on the housing that causes little obstruction to the flow of air through the through opening, and the lamp can be mounted in the through opening only by engagement of a rim around the second end of the lamp with the housing and engagement of the contacts with the receptacle so that the air from the fan can flow along almost the entire outer surface of the lamp to cool the lamp.

The opening through the housing portion between its first and second ends can have a cross sectional area of at least about 4.0 square inches (25.8 square centimeters), such as a cross sectional area of at least about 4.9 square inches (31.6 square centimeters); and the air passageways can have a total cross sectional area of at least about 0.84 square inches (5.42 square centimeters) such as in the range of about 1 to 1.25 square inch (6.45 to 8.06 square centimeters), and can be portions of the through opening around the second end of the lamp.

The lamp cooling system of the light assembly is sufficiently efficient that its housing can be molded of relatively inexpensive polymeric materials such as about 0.08 inch (0.2 cm) thick acrylonitrile-butadiene-styrene (ABS).

### DESCRIPTION OF DRAWING

The present invention will be further described with reference to the accompanying drawing wherein like reference numerals refer to like parts in the several views, and wherein:

FIG. 1 is a perspective view of a portable cordless inspection light assembly according to the present invention;

FIG. 2 is a side view of the inspection light assembly of FIG. 1 from which has been removed one portion of a housing for the assembly, an end cap for the housing and a battery assembly;

FIG. 3 is a fragmentary front view of the inspection light assembly of FIG. 1;

FIG. 4 is a fragmentary sectional view taken approximately along line 4-4 of FIG. 1;

FIG. 5 is a fragmentary sectional view taken approximately along line 5-5 of FIG. 1; and

FIG. 6 is an enlarged fragmentary sectional view taken approximately along line 6-6 of FIG. 1.

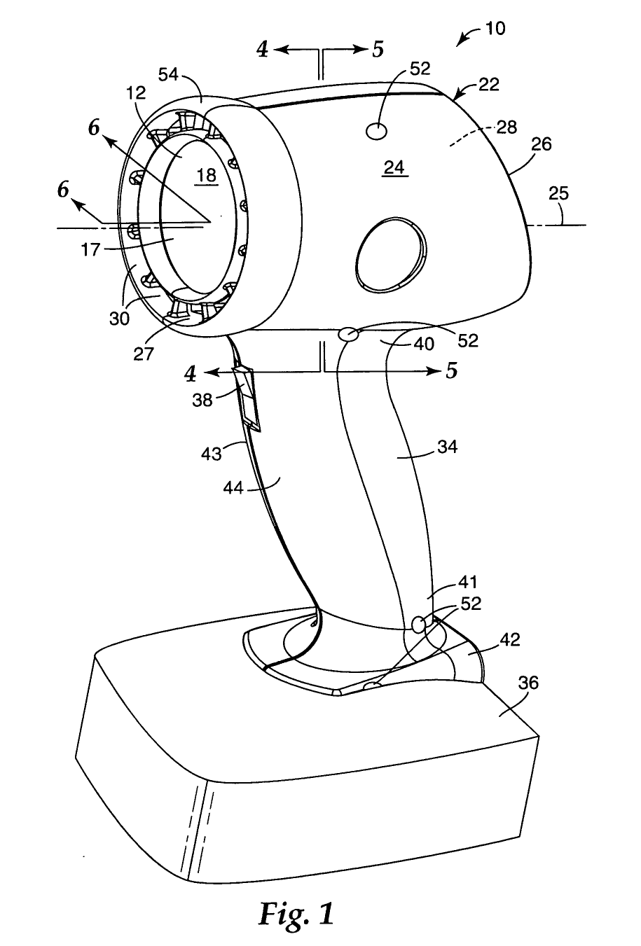

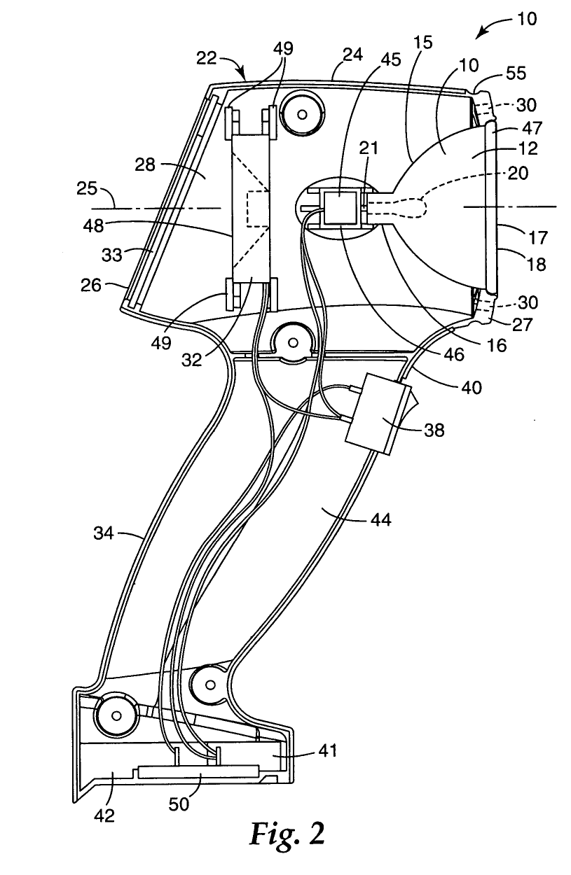

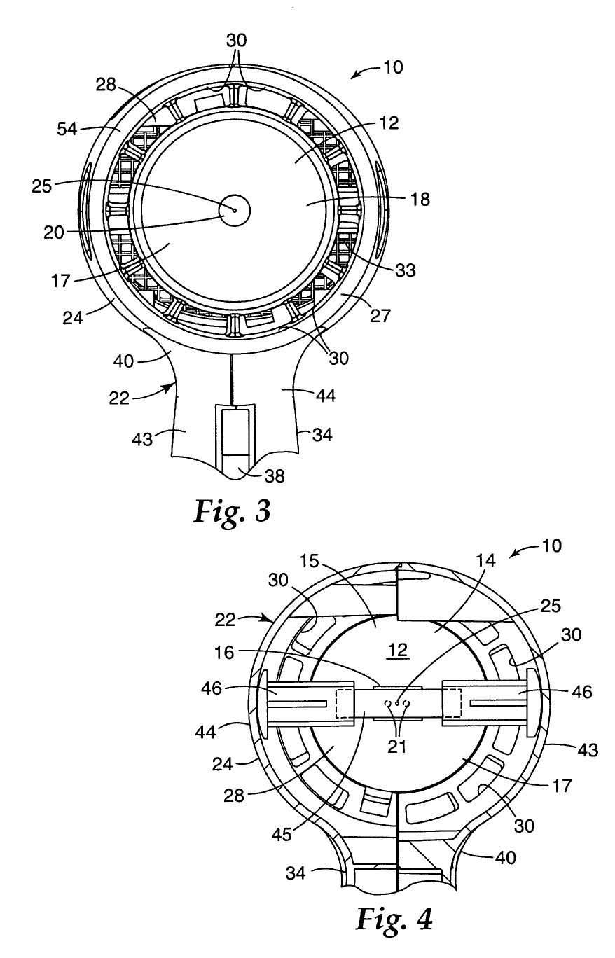

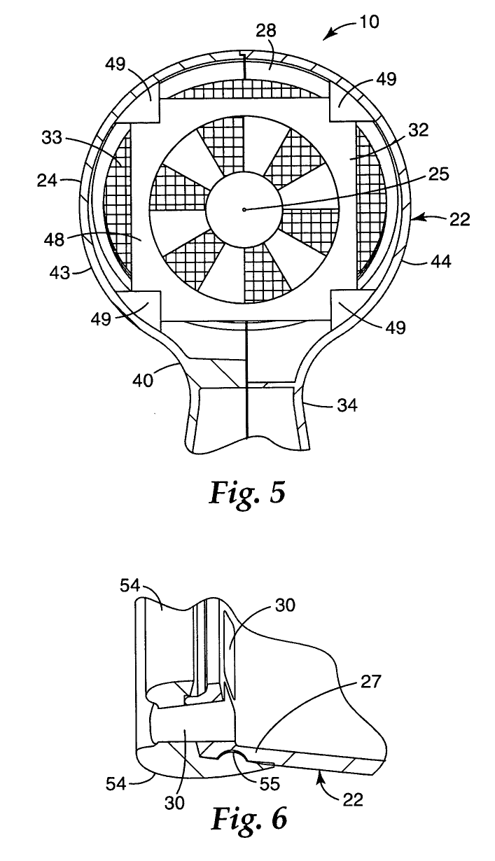

### DETAILED DESCRIPTION OF THE INVENTION

Referring now to the drawing there is illustrated a portable cordless inspection light assembly according to the present invention that is generally identified by the reference numeral 10.

Generally, the portable cordless inspection light assembly 10 includes a lamp 12 capable of producing a spectral distribution which is substantially identical to daylight color temperature (e.g., the lamp described in U.S. Pat. No. 5,418,419, the content whereof is incorporated herein by reference, such as the lamp commercially available under the trade designation “SoLux” 4700K lamp from Tailored Lighting Inc, Pittsford, N.Y.). The lamp 12 has first and second opposite ends 16 and 17, and an outer surface 15.

The lamp 12 has a larger cross sectional area at its second end 17 than at its first end 16, has a generally parabolic reflector portion 14 adjacent its second end 17 and a light outlet lens 18 across its second end 17, and has an electrically operable bulb 20 partially within its reflector portion 14 with electrical contacts in the form of contact pins 21 for the bulb 20 projecting from its first end 16. The inspection light assembly 10 also includes a housing 22 comprising a generally tubular housing portion 24 having an axis 25, a first or inlet end 26, a second or outlet end 27, and a through axially extending opening 28 between its ends 26 and 27 having a cross sectional area of about 4.9 square inches (31.6 square centimeters). Means are provided for mounting the lamp 12 within the opening 28 with the second end 17 of the lamp 12 transverse of the opening 28 adjacent the second end 27 of the housing portion 24 and the lamp 12 between its second and first ends 17 and 16 within the through opening 28 and projecting toward the first end 26 of the housing portion 24 with almost all of the outer surface 15 of the lamp between its ends 16 and 17 exposed within the through opening 28. Means are also provided for forming exhaust air passageways 30 communicating externally of the housing portion 24 from the through opening 28 around the outer surface 15 of the lamp 12 at its second end 17. Those air passageways 30 have a total cross sectional area of at least about 0.84 square inches (5.42 square centimeters), such as about 1 square inch (6.45 square centimeters) which is about 20 percent of the cross sectional area of the opening 28 at the first end 26 of the housing portion 24, and are portions of the through opening 28 around the second end 17 of the lamp 12. A fan assembly 32 is mounted on the housing 22 within the opening 28 through the housing portion 24. The fan assembly 32 is electrically operable to propel air through the opening 28 from the first or inlet end 26 toward the second end 27 of the housing portion 24 over and along the outer surface 15 of the lamp 12 axially from its first end 16 to its second end 17 and then through the air passageways 30 around the second end 17 of the lamp 12. The housing 22 further includes a handle portion 34 adapted for manual engagement, and means for supporting a rechargeable battery on the housing 22; and the inspection light assembly 10 includes means for making electrical connections between a battery supported on the housing 22 and the bulb 20 and the fan assembly 32, which means includes manually operated switch means 38 for connecting or disconnecting electrical power between the battery and the bulb 20 and fan assembly 32.

The fan assembly 32 is of the type sometimes called a D.C. muffin fan and should produce an axial air flow through the opening 28 and air passageways 30 of at least about 2.75 cubic feet per minute (0.078 cubic meters per minute), and preferably of at least 3.26 cubic feet per minute (0.09 cubic meters per minute). A suitable fan assembly 32 for use in the inspection light assembly 10 is that commercially identified as “SUNON (trademark) KD1205PFB1, DC12V, 1.6 W″ that is commercially available from Digikey, Thief River Falls, Minn. That fan assembly is rated at 11 cubic feet per minute (0.31 cubic meters per minute) and produces an axial air flow through the opening 28 and air passageways 30 of about 3.26 cubic feet per minute (0.09 cubic meters per minute), which has been found to maintain the outer surface temperature of the outer rim at the second end 17 of the lamp 15 that contacts the housing 22 at about 172° F. (77.8° C.) when the bulb 20 is connected to 12 volt D.C. electrical power and operated for an extended period of time. This temperature is below the softening temperature of many polymeric materials used to make housings so that the housing 22 can be formed of such polymeric materials.

The light assembly 10 includes a grille or screen 33 (e.g., screen of 0.03 inch or 0.08 centimeter diameter steel wire with 0.05 inch or 0.13 centimeter wide square openings between the wires) supported across the opening 28 at the first or inlet end 26 of the housing portion 24 to restrict contact with the fan assembly 32 while allowing free air flow into the opening 28.

The handle portion 34 has a first end 40 fixed to the housing portion 24 about midway between its first and second ends 26 and 27, is elongate, projects away from the housing portion 24, and has a second end 41 opposite its first end 40 that includes the means for supporting the battery on the housing 22. The handle portion 34 has a length and cross sectional shaped adapted to be easily grasped by a person's hand, and the manually operated switch means comprises the rocker switch 38 pivotally mounted adjacent the first end 40 of the handle portion 34 on the side of the handle portion 34 adjacent the second end 27 of the housing portion 24 where the switch 38 can be easily operated by the index finger of a person grasping the handle portion 34. The switch 38 can simultaneously connect or disconnect an electrical connection between the battery and the bulb 20 and an electrical connection between the battery and the fan assembly 32.

The rechargeable battery is in a 12 volt rechargeable battery pack assembly 36 such as that commercially designated Model DC 9077XRP Battery Pack that is commercially available from DeWalt Industrial Tool Co., Baltimore, Md. The battery pack assembly 36 is removeably mounted on battery pack assembly receiving and support structure 42 at the second end 41 of the handle portion 34 that is adapted to be releaseably engaged by the battery pack assembly 36, and when so engaged to support the battery pack assembly 36 and make electrical connection between electrical contacts on the support structure 42 and electrical contacts on the battery pack assembly 36.

The housing 22 includes two generally allochiral molded portions 43 and 44 each of about 0.08 inch (0.2 cm) thick acrylonitrile-butadiene-styrene (ABS). A groove around the inner surface of the second end 27 of the tubular portion 24 receives and supports a rim 47 around the periphery of the second end 17 of the lamp 12. Posts 46 projecting into the opening 28 from opposite sides of the housing portion 24 have sockets at their opposite spaced distal ends that receive opposite end portions of an electrical receptacle 45 engaged with the pins 21 at the first end 16 of the lamp 12 so that the posts 46 and receptacle 45 together with the groove around the inner surface of the outlet end 27 of the tubular portion 24 provide the entire support for the lamp 12 in the housing 22. The receptacle 45 engaged with the pins 21 at the first end 16 of the lamp 12 and the posts 46 for supporting the receptacle on the housing extend transversely across the opening 28 and have a area transverse of the opening 28 of less than about 1.3 square inches (8.4 square centimeters), and preferably of about 1.1 square inches (7.1 square centimeters) which leaves portions of the opening above and below the receptacle 45 and posts 46 having a combined area of over 4.9 square inches (31.6 square cm) through which air can flow. Recesses in projections 49 projecting into the opening 28 from opposite sides of the tubular portion 24 receive and support the four corners of a fixed portion 48 of the fan assembly 32. The groove around the inner surface of the tubular portion 24 at its first end 26 receives and supports the peripheral edge of the grille 33. Spaced edges of the housing portions 43 and 44 form a socket in which the switch 38 is supported and retained. Opposing sockets formed at the second end 41 of the handle portion 34 receive and support a plate 50 carrying electrical contacts for the battery 36. The lamp 12, receptacle 44, fan assembly 32, grille 33, switch 38, and plate 50 are retained in position within the housing 22 by screws 52 that attach together the molded portions 43 and 44 of the housing 22, and by a circular collar 54 that releasably engages over the second end 27 of the tubular portion 24 with a radially inwardly projecting annular lip on the collar 54 received in a groove 55 around the outer surface of the tubular portion 24.

The cooling system for the lamp 12 of the light assembly 10 provided by the housing portion 24, the air passageways 30 communicating externally of the housing portion 24 from the through opening 28 around the outer surface 15 of the lamp 12 at its second end, the fan assembly 32, the grille 33, and the means for supporting the lamp 12 in the through opening with almost all of the outer surface 15 of the lamp 12 between its first and second ends 16 and 17 exposed and so that air from the fan assembly 32 will flow axially from its first end 16 to its second end 17 along that outer surface 15 is sufficiently efficient to maintain temperatures along that outer surface 15 that, even with extended operation of the lamp 12, will not soften the polymeric housing 22 in which the lamp 12 is mounted. For example, in one test in which the example lamp 12 and fan assembly 32 indicated above were operated for 12 minutes in an ambient temperature of abut 72° F. while providing air flow through the opening 28 and air passageways 30 of about 3.26 cubic feet per minute, the temperature of the rim of the lamp 12 at its second end 17 that contacts the housing 22 was about 169° F. (76° C.) with the adjacent housing 22 temperature being about 147° F. (64° C.), the temperature of the lamp 12 at the end of the reflector portion 14 adjacent the first end 16 of the lamp 12 was about 311° F. (155° C.), and the temperature of the reflector portion 14 about midway between those locations was about 228° F. (109° C.). Little change in these temperatures occurred when ¼ of the areas of the air passageways 30 were blocked to reduce air flow through the opening 28 and air passageways 30, however, when ½ of the areas of the air passageways 30 were blocked to reduce air flow through the opening 28 and air passageways 30 the temperature of the rim of the lamp 12 at its second end 17 that contacts the housing 22 rose to about 181° F. (83° C.) with the adjacent housing 22 temperature being about 165° F. (74° C.), the temperature of the lamp 12 at the end of the reflector portion 14 adjacent the first end 16 of the lamp 12 rose to about 361° F. (183° C.), and the temperature of the reflector portion 14 about midway between those locations rose to about 252° F. (122° C.) which caused undesirable softening of the housing 22.

The present invention has now been described with reference to one embodiment. It will be apparent to those skilled in the art that many further changes can be made in the embodiment described above without departing from the scope of the present invention. For example, the means for forming air passageways communicating externally of the housing portion from the through opening 28 around the outer surface 15 of the lamp 12 at its second end 17 could be provided by radially extending openings in the housing portion 24. The inspection light assembly 10 could have a grille of polymeric material across the opening 28 at the first or inlet end 26 of the housing portion instead of the wire screen 33, which grill might cause slightly greater restriction to air flow than the screen, but could provide the advantage that it could be made in two parts, each part being integrally molded with a different one of the portions 43 and 44 of the housing 22. The fan assembly could be positioned to draw air in through the air passageways 30 and over the outer surface 15 of the lamp 12 from the second end 27 of the housing portion 24 and exhaust the air from the opening 28 at the first end of the housing portion 24. Instead of including a battery mounted on the housing, the means for connecting a source of electrical power to the bulb and fan assembly could include a cord from a power supply not mounted on the housing such as a power supply including a transformer and rectifier that can be engage a source of A.C. power. The lamp used could be a lamp other than the lamps described above such as a halogen lamp, in particular those having a Color Rendition Index (CRI) of at least 80, and more preferably a CRI of 100, such lamps being commercially available under the trade designations “HIR PAR”, “HIR Ultra XL PAR” and “ConstantColor Precise MR16” from GE Lighting, Wilton, Conn. The cross sectional shape of the housing portion 24 could be other than generally cylindrical, and cross sectional shape could vary along its length. The housing 22 could be made of metal rather than polymeric material. The handle portion adapted for manual engagement could be provided by the outer surface of the housing portion so that the inspection light assembly is grasped like a conventional flashlight. The inspection light assembly could be made with more than one lamp and more than one fan assembly, such as with parallel generally tubular housing portions each containing a fan assembly and a lamp with the lamps having different color temperature ratings and being separately operable for different purposes. Thus, the scope of the present invention should not be limited to the structures and methods described in this application, but only by the structures and method described by the language of the claims and the equivalents thereof.

What is claimed is:

1. A portable inspection light assembly comprising:
a lamp having first and second opposite ends, having an outer surface between said ends, having a larger cross sectional area at said second end than at said first end, and comprising an electrically operable bulb with electrical contacts for said bulb at said first end;
a housing comprising a generally tubular housing portion having an axis, a first end, a second end, and a through axially extending opening between said ends;
means for mounting said lamp within said opening with the second end of said lamp transverse of said opening adjacent said second end of said housing portion and with the lamp between the first and second ends of the lamp extending along said through opening toward the first end of said housing portion;
means for providing air passageways communicating externally of said housing portion from said through opening around the outer surface of said lamp adjacent the second end of said lamp;
a fan assembly within said opening through said housing portion, said fan assembly being electrically operable to propel air through said opening between said ends of said housing portion over said outer surface of said lamp and through said air passageways;
said housing further comprising a handle portion adapted for manual engagement; and
means for connecting a source of electrical power to said bulb and said fan assembly.

2. An inspection light assembly according to claim 1 wherein said electrical contacts for said bulb are pins projecting from said second end of said lamp, said inspection light assembly includes a receptacle engaged with the pins at the first end of the lamp and means for supporting the receptacle on the housing, the lamp has a rim around the second end of said lamp, and said lamp is mounted in said opening only by engagement of said rim with said housing and said pins with said receptacle.

3. An inspection light assembly according to claim 2 wherein said opening through said housing portion between said inlet and outlet openings has a cross sectional area of at least about 4.0 square inches (25.8 square centimeters), said air passageways have a total cross sectional area of at least about 0.84 square inch (5.42 square centimeters), and said receptacle engaged with the pins at the first end of the lamp and means for supporting the receptacle on the housing extend transversely across said opening through said housing portion and have an area transverse to said opening of less than about 1.3 square inches (8.4 square centimeters).

4. An inspection light assembly according to claim 2 wherein said opening through said housing portion has a cross sectional area of at least about 4.9 square inches (31.6 square centimeters), said air passageways have a total cross sectional area of about 1 square inch (6.45 square centimeters), and said receptacle engaged with the pins at the first end of the lamp and means for supporting the receptacle on the housing extend transversely across said opening through said housing portion and have an area transverse to said opening of about 1.1 square inches (7.1 square centimeters).

5. An inspection light assembly according to claim 1 wherein said lamp is capable of producing a spectral distribution which is substantially identical to daylight color temperature, said lamp having a reflector portion adjacent said second end and a light outlet lens across said second end with said bulb being partially within said reflector portion; and wherein said opening through said housing portion has a cross sectional area of at least about 4.4 square inches (28.4 square centimeters) and said air passageways have a total cross sectional area of at least about 0.84 square inch (5.42 square centimeters).

6. An inspection light assembly according to claim 1 wherein said air passageways are portions of said through opening extending past the second end of said lamp.

7. An inspection light assembly according to claim 1 wherein said housing is a two piece molding of about 0.08 inch (0.2 cm) thick acrylonitrile-butadiene-styrene.

8. An inspection light assembly according to claim 1 wherein said means for connecting a source of electrical power to said bulb and said fan assembly includes means for supporting a battery on said housing and means for making electrical connections between a battery on said means for supporting and said bulb, and said fan assembly includes manually operated switch means for connecting or disconnecting power between said means for making electrical connections and said bulb and fan assembly.

9. An inspection light assembly according to claim 8 wherein said handle portion has a first end fixed to said tubular portion between said inlet and outlet ends, is elongate, projects away from said tubular portion, and has a second end opposite said first end, said means for supporting a battery on said housing supports the battery at the second end of said handle portion, and said manually operated switch means is mounted on said handle portion adjacent the first end of the handle.

10. An inspection light assembly according to claim 1 further including a screen across said opening at the first end of said tubular portion.

11. An inspection light assembly according to claim 1 wherein said fan assembly propels air through said opening from said first end to said second end of said housing portion end and out of said air passageways.

12. A portable cordless inspection light assembly comprising:
a lamp capable of producing a spectral distribution which is substantially identical to daylight color temperature, said lamp having first and second opposite ends, having an outer surface between said ends, having a larger cross sectional area at said second end than at said first end, having a reflector portion adjacent said second end and a light outlet lens across said second end, and having an electrically operable bulb partially within said reflector portion with electrical contact pins for said bulb at said first end;
a housing comprising a generally tubular housing portion having an axis, a first end, a second end, and a through axially extending opening between said ends;
means for mounting said lamp within said opening with the second end of said lamp transverse of said opening adjacent the second end of said housing portion and with the lamp between the second and first ends of the lamp extending along said through opening toward the first end of said housing portion;
means for providing air passageways communicating externally of said housing portion from said through opening around the outer surface of said lamp and adjacent the second end of said lamp;
a fan assembly within said opening through said housing portion, said fan assembly being electrically operable to propel air through said opening between the first and second ends of said housing portion over said outer surface of said lamp, and through said air passageways around the second end of said lamp;
said housing further comprising a handle portion adapted for manual engagement, and means for supporting a battery on said housing; and
said inspection light including means for making electrical connections between a battery on said means for supporting and said bulb and said fan assembly.

13. An inspection light assembly according to claim 12 wherein said electrical contacts for said bulb are pins projecting from the second end of said lamp, said inspection light assembly includes a receptacle engaged with the pins at the first end of the lamp and means for supporting the receptacle on the housing, the lamp has a rim around the second end of said lamp, and said lamp is mounted in said opening only by engagement of said rim with said housing and said pins with said receptacle.

14. An inspection light assembly according to claim 13 wherein said opening through said housing portion has a cross sectional area of at least about 4.0 square inches (25.8 square centimeters), said air passageways have a total cross sectional area of at least about 0.84 square inch (5.42 square centimeters), and said receptacle engaged with the pins at the first end of the lamp and means for supporting the receptacle on the housing extend transversely across said opening through said housing portion and have an area transverse to said opening of less than about 1.3 square inches (8.4 square centimeters).

15. An inspection light assembly according to claim 12 wherein said opening through said housing portion has a cross sectional area of at least about 4.9 square inches (31.6 square centimeters) and said air passageways have a total cross sectional area of at least about 0.84 square inch (5.42 square centimeters).

16. An inspection light assembly according to claim 12 wherein said opening through said housing portion has a cross sectional area of about 4.9 square inches (31.6 square centimeters) and said air passageways have a total cross sectional area of about 1.1 square inch (7.1 square centimeters).

17. An inspection light assembly according to claim 12 wherein said air passageways are portions of said through opening extending past the second end of said lamp.

18. An inspection light assembly according to claim 12 wherein said housing is a two piece molding of about 0.08 inch (0.2 cm) thick acrylonitrile-butadiene-styrene.

19. An inspection light assembly according to claim 12 wherein said handle portion has a first end fixed to said tubular portion between said inlet and outlet ends, is elongate, projects away from said tubular portion, and has a second end opposite said first end, said means for supporting a battery on said housing supports the battery at the second end of said handle portion.

20. An inspection light assembly according to claim 12 wherein said fan assembly propels air through said opening from said first end to said second end of said housing portion and out of said air passageways.
